(19) United States
(12) Patent Application Publication
(10) Pub. No.: US 2023/0321585 A1
(43) Pub. Date: Oct. 12, 2023

(54) EXHAUST GAS TREATMENT SYSTEM

(71) Applicants: JOHNSON MATTHEY PUBLIC LIMITED COMPANY, London (GB); JOHNSON MATTHEY CATALYSTS (GERMANY) GmbH, Redwitz an der Rodach (DE)

(72) Inventors: Joseph FEDEYKO, Wayne, PA (US); Kenneth KOEHLER, Audubon, PA (US); Dirk REICHERT, Redwitz an der Rodach (DE); Thomas Manning YEH, Audubon, PA (US)

(21) Appl. No.: 18/069,579

(22) Filed: Dec. 21, 2022

Related U.S. Application Data
(60) Provisional application No. 63/266,786, filed on Jan. 14, 2022.

(51) Int. Cl. B01D 53/04; B01D 53/26; B01D 53/00; B01D 53/86; B01D 53/75

(52) U.S. Cl. CPC B01D 53/0446; B01D 53/002; B01D 53/0438; B01D 53/261; B01D 53/75; B01D 53/8634; B01D 53/8668; B01D 53/8687; B01D 2257/406; B01D 2257/7025; B01D 2257/708; B01D 2257/80; B01D 2258/02; B01D 2258/0266; B01D 2259/40003; B01D 2259/4009; B01D 2259/4508

(57) ABSTRACT

An exhaust system for the treatment of a humid exhaust gas comprising a species to be treated, the system comprising: a dehumidifier system comprising a humid air inlet for providing a flow of humid exhaust gas; a first gas inlet for providing a flow of dehumidified exhaust gas; a second gas inlet for providing a flow of heated gas; a plurality of sorbent beds for releasably storing the species; a treatment unit comprising either: one or more catalysts for decomposing the species; or a condensing unit for recovering the species in liquid or aqueous form; first and second exhaust gas outlets; and a valve system configured to establish independently for each sorbent bed fluid communication in a first or second configuration, wherein: i) in the first configuration the flow of the dehumidified exhaust gas from the first gas inlet contacts a sorbent bed for storing the species and then passes to the first gas outlet; and ii) in the second configuration the flow of heated gas from the second gas inlet contacts a sorbent bed for releasing the species, passes to the treatment unit and then passes to the second exhaust gas outlet; wherein the valve system is configured to ensure that at least one sorbent bed is in the first configuration and, preferably at least one other sorbent bed is in the second configuration; wherein the flow of dehumidified exhaust gas provided by the first gas inlet is received from the dehumidifier system.

The present invention relates to a system and method for the treatment of an exhaust gas and, in particular, for the treatment of a humid exhaust gas comprising relatively low concentrations of species which need to be treated. The system may be particularly useful for treating emissions comprising species such as ammonia and formaldehyde which are produced from some sources at low concentrations, such as ammonia produced from livestock houses or formaldehyde in heating, ventilation, and air conditioning (HVAC) systems.

Animals are often reared in a relatively small space such as a barn, coop, or shed (“houses”). This confined space can potentially lead to high concentrations of pollutants in the contained gas atmosphere. Typical pollutants include NH₃, VOCs, H₂S, bioaerosols such as organic or inorganic particulates which can arise from feed and manure particles and may include bacteria, and the like. Therefore, air quality within the barn is a concern for both animal and workers health. Furthermore, emissions ventilated to the outside can cause problems and may be subject to emissions limits.

For example in poultry rearing, it is required that NH₃ should be limited in the poultry breathing air to 25 ppm (OSHA in the US). While this is attainable, concentrations as high as 50-200 ppm are also known. Emissions typically are not constant and increase with number, age and activity of the animals (VDI 4255 part 2).

For animal breeding, the air exchange rate in the barn/house depends on the outside temperatures. In summer exchange rates may be high, whereas in colder whether it typically is very low to avoid generating too much of a draft, which can impact animal health. A low air exchange rate worsens the pollutant concentrations in the air which the animals/workers breathe.

There is a particular focus at the moment on decreasing the pollutant concentrations inside of the barn and also emission to the outside. The current state-of-the-art to minimise these organic and inorganic air pollutants relies on scrubber and biofilter systems which have an associated high investment cost. In operation a relatively high volume of fresh water is used and therefore a high volume of organically-polluted grey water is attained.

Another field of application which encounters similar problems is the cleaning of building room air, in which formaldehyde, carbon monoxide and also bioaerosols pose health threats to humans.

DE 4427491 A1 relates to methods for the stationary disposal of sorbable chemical compounds comprising UV photolysis of a fluid stream comprising said compounds and ozone. Undesired by-products of said photolysis such as NOₓ may be treated by a catalytic converter.

EP 2581127 A1 relates to a method of air purification whereby pollutants, preferably VOCs, are broken down by means of UV radiation, preferably by means of photooxidation and residual pollutants may be oxidised by a catalytic converter.

US 2015/118138 A1 relates to an apparatus and method for decomposing an ultra-low concentration of volatile organic compounds.

Accordingly, it is desirable to provide an improved system and method for treating such exhaust gases and/or to tackle at least some of the problems associated with the prior art or, at least, to provide a commercially viable alternative thereto. Exhaust gases from livestock houses and buildings comprising HVAC systems, for example, comprise water/moisture such that there remains a need for the abatement of pollutants which are present in humid exhaust gases. In particular, it is an aim to achieve catalytic destruction of pollutants directly in the gas phase for recirculation of the air back to the inside or venting to the outside.

According to a first aspect there is provided an exhaust system for the treatment of a humid exhaust gas comprising a species to be treated, the system comprising:
a dehumidifier system comprising a humid air inlet for providing a flow of humid exhaust gas;
a first gas inlet for providing a flow of dehumidified exhaust gas;
a second gas inlet for providing a flow of heated gas;
a plurality of sorbent beds for releasably storing the species;
a treatment unit comprising either:
   one or more catalysts for decomposing the species; or
   a condensing unit for recovering the species in liquid or aqueous form;
first and second exhaust gas outlets; and
a valve system configured to establish independently for each sorbent bed fluid communication in a first or second configuration, wherein:
   i) in the first configuration the flow of the dehumidified exhaust gas from the first gas inlet contacts a sorbent bed for storing the species and then passes to the first gas outlet; and
   ii) in the second configuration the flow of heated gas from the second gas inlet contacts a sorbent bed for releasing the species, passes to the treatment unit and then passes to the second exhaust gas outlet;
wherein the valve system is configured to ensure that at least one sorbent bed is in the first configuration and, preferably at least one other sorbent bed is in the second configuration;
wherein the flow of dehumidified exhaust gas provided by the first gas inlet is received from the dehumidifier system.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The present invention allows for the direct catalytic treatment of species to be treated in the gas phase. In particular, the invention provides for treatment of air pollutants in low concentrations and at low temperature directly in the gas phase of a humid exhaust gas without the use of a liquid phase like in scrubber or biofilter systems. The low temperature catalytic gas treatment system can operate with only electrical power for fans and gas heaters and does not have any constantly-incurred by-products except for spent sorbent material or catalyst.

Direct treatment of a low temperature exhaust gas with a catalyst tends to have a low conversion efficiency. Known catalysts tend to operate more effectively at temperatures well above ambient. To make the input of energy to heat the exhaust gas efficient, it is not desirable to treat large volumes of exhaust gases with low contaminant concentration levels. The inventors have now found that the system and method described herein overcome these problems. In particular, the concentration of the species to be treated (or “contaminant”) can be significantly increased so that the heated catalyst is only required to treat a smaller volume of contaminant-rich exhaust gas.

The inventors have found that they can apply technologies generally used in the automobile exhaust field, such as ammonia slip catalysts and ammonia storage beds, to treat low level exhaust concentrations. This system is particularly advantageous for treating gases which are provided at low temperatures (such as at or around ambient) and at low concentrations (even down to 10s of ppm levels). The following discussion will focus generally on ammonia treatment of gases from livestock houses, but it should be appreciated that the application of the system can be more broadly applied as noted below.

The present invention relates to an exhaust system for the treatment of an exhaust gas comprising a species to be treated. Specifically, the present invention relates to an exhaust system for the treatment of a humid exhaust gas comprising a species to be treated, the system comprising a dehumidifier system and a valve system.

The dehumidifier system is arranged upstream of the valve system and treatment unit for treating the species and provides a flow of dehumidified exhaust gas to the remainder of the exhaust system by dehumidifying a humid exhaust gas comprising the species to be treated. The dehumidifier comprises a humid air inlet for providing a flow of humid exhaust gas (such as an exhaust gas from a livestock house comprising ammonia). The dehumidifier provides a flow of dehumidified exhaust gas to the first gas inlet of the exhaust system of the invention.

The exhaust system comprises a dehumidifier system for removing water independently of other gases. By removing water from, for example, livestock house air, ventilation and water concentration can be decoupled. Through the decoupling of water from livestock house air, energy savings, particularly in cooler temperatures, can be increased by reducing the air purge from the house while the water vapour concentration still remains at a low enough level where livestock health and value are not impacted.

By selectively removing water (in addition to the pollutant species in a separate step), the amount of purged air can be reduced, meaning less fresh air is required to be brought in the house which results in lower heating costs.

The inventors have found that the moisture content of an exhaust gas inhibits the mechanism of the other treatment systems. For example, moisture has been found to reduce catalyst performance by blocking active sites. In terms of heating efficiency, the inventors have also found that increased energy was required to heat humid exhaust gas reducing the overall efficiency of the system.

The first gas inlet, second gas inlet, plurality of sorbent beds, treatment unit, first and second exhaust gas outlets and valve system of the exhaust system will now be further described under the section heading “valve system” and therefore relates to the section of the exhaust system downstream of the dehumidifier system for the treatment of the species.

### Valve System

An exhaust gas is a gas to be emitted or discharged. In the context of the present invention, the exhaust gas is a humid gas containing a build-up of contaminants which needs to be treated to ensure that emissions limits are met, or to ensure that an internal environment is kept at tolerable levels in view of health and safety considerations. In the context of a livestock house (for example, a poultry house or a swine house), the exhaust gas is the air within the house which contains contaminants such as NH₃ produced by animals, which is taken out of the house to be processed within the exhaust gas system described herein, either to be emitted to the outside or recycled into the house atmosphere.

The system comprises a first gas inlet for providing a flow of exhaust gas. The first gas inlet provides the exhaust gas to be treated (specifically the dehumidified exhaust gas). The exhaust gas (i.e. humid exhaust gas) is taken from an atmosphere containing a species to be treated, such as a livestock house. The exhaust gas may be drawn into the inlet with a fan, and typically involves a conventional air intake within, for example, a livestock house air handling system.

The system comprises a second gas inlet for providing a flow of heated gas. The second gas inlet may draw in fresh air from outside of the system or may also rely on a flow of exhaust gas taken in from the atmosphere containing a species to be treated and dehumidified by the dehumidifier system. There are advantages to drawing in fresh air since this avoids contacting contaminants with the source of heat. For example, if an electrical induction heater is used, this can become degraded with airborne contaminants during use.

Where the second gas inlet provides a flow of heated exhaust gas (rather than fresh air), the first and second gas inlets are preferably split from a single gas inlet. That is, a single exhaust gas stream is divided, such as with a y-shaped tubing configuration, to provide the first and second gas inlets as different forks in the gas flow path. Thus, the single gas inlet draws in the exhaust gas to be treated from the dehumidifier system containing the species to be treated and divides it into two, passing a portion to the first inlet and a portion to the second inlet. This is advantageous since a single intake can be relied upon with a single fan to circulate the gases.

The volume of gas passing through the second gas inlet may be reduced compared to the volume of gas passing through the first gas inlet. That is, a majority of gas may be used to charge the sorbent beds, but the volume of gas being used to discharge a sorbent bed is preferably reduced to minimise the gas volume to be treated. Preferably the gas flow through the second gas inlet is at most defined by the total gas volume through the system divided by the number of sorbent beds in the system, and most preferably from 0.5 to 1, more preferably 0.6 to 0.8 times this value.

The first gas inlet will provide gas at the ambient temperature of the source gas. In the context of a livestock house, this will typically be from 10 to 40° C. Preferably the humid exhaust gas entering the system and/or the dehumidified exhaust gas entering the first gas inlet is at a temperature at least 25° C. below an effective catalyst treatment temperature and preferably is at ambient temperature. The effective catalyst treatment temperature is a temperature at which the catalyst is capable of operating at 25% of maximum efficiency. Preferably the exhaust gas will be at 5 to 60° C., preferably at 5 to 50° C., more preferably 10 to 40° C. and most preferably 20 to 30° C.

The second gas inlet provides a flow of heated gas, such that the second gas inlet provides gas that is hotter than the gas from the first gas inlet. The system is therefore configured so that the flow of exhaust gas from the first gas inlet is at a temperature suitable for storage on the sorbent bed, whereas the flow of heated gas from the second gas inlet is at a higher temperature and is suitable for causing the release of at least a portion of the stored gas on the sorbent bed. That is, the species to be treated is then desorbed from the sorbent bed with a smaller volume of heated gas than the volume of gas from which it has been recovered (i.e. the concentration of the species is increased).

Preferably the second gas inlet incorporates a heating device for providing the flow of heated gas. Preferably the heating device is configured to provide a flow of gas at a temperature of from 100 to 600° C., preferably 100 to 350° C., preferably 150 to 200° C. The target temperature will depend on the heat needed to release stored species from the downstream sorbent bed.

The heater can be electrical or based on combustion of a fuel. Preferably the heater is a gas burner, preferably a propane, natural gas or biogas burner. These are useful especially for locations such as livestock houses, since there tend to be available supplies of propane and the like on such sites. In one embodiment, propane may be supplied with gas from the first and/or second exhaust gas outlet as an oxygen source for combustion. Such an afterburner serves to further purify the gas being treated.

Preferably, the flow of heated gas is heated with heat obtained from the catalytic treatment of the species. By recycling the heat obtained from the exothermic decomposition of the species, the system can be maintained in an autothermal condition. In other words, the system can operate continuously without requiring any input of heat from an external heater but solely from the heat generated by the catalytic decomposition further improving the efficiency of system. This is particularly effective where the flow of heated exhaust gas is portion of the dehumidified exhaust gas as the inventors found that the absence of moisture increased the efficiency of heating the exhaust gas. Accordingly, with improved energy recycling, sufficient heat may be retained from the catalytic treatment and transferred to exhaust gas to be treated so as to maintain autothermal conditions.

The system comprises a plurality of sorbent beds for releasably storing the species. Sorbent beds are well known in the art and the material of the bed can be selected depending on the material to be stored. Suitable sorbents include, for example, activated carbon, such as activated coal, silica gel, Al₂O₃ and most preferably zeolite beds. These materials are well known for use in treating automobile exhaust gases. When seeking to store ammonia, for example, any known ammonia storage material composition can suitably be used. Sorbent materials are used to accumulate the material to be stored under normal flow conditions but when heated release the stored material. In this way the gaseous contaminant is concentrated on the solid storage material before being released into the gas phase in a more concentrated form.

Zeolites are constructed of repeating SiO₄, AlO₄, tetrahedral units linked together, for example in rings, to form frameworks having regular intra-crystalline cavities and channels of molecular dimensions. The specific arrangement of tetrahedral units (ring members) gives rise to the zeolite’s framework, and by convention, each unique framework is assigned a unique three-letter code (e.g., “CHA”) by the International Zeolite Association (IZA). Zeolites may also be categorised by pore size, e.g. a maximum number of tetrahedral atoms present in a zeolite’s framework. As defined herein, a “small pore” molecular sieve, such as CHA, contains a maximum ring size of eight tetrahedral atoms, whereas a “medium pore” molecular sieve, e.g. MFI, contains a maximum ring size of ten tetrahedral atoms; and a “large pore” molecular sieve, such as BEA, contains a maximum ring size of twelve tetrahedral atoms.

A most preferred zeolite for the storage of ammonia is a small-pore zeolite. Small pore zeolites are more selective for ammonia and so may reduce competition for ammonia storage when other gaseous species are present. Preferably the small-pore zeolite has a framework structure selected from the group consisting of AEI, AFT, AFV, AFX, AVL, CHA, EMT, GME, KFI, LEV, LTN, and SFW, including mixtures of two or more thereof. It is particularly preferred that the zeolite has a CHA or AEI-type framework structure.

The zeolite may be in its H+-form or may be loaded (for example, ion-exchanged) with a metal. Copper and/or iron loading is particularly preferred. Where a metal-loaded zeolite is employed, the zeolite may have a metal-loading in the range 1 to 6 wt%, preferably 3-5.5 wt% and most preferably about 4 wt%.

The sorbent material may preferably be disposed on a suitable substrate such as a honeycomb monolith, a corrugated substrate (such as corrugated glass-paper or quartz fibre sheet) or a plate. Alternatively, the sorbent material (storage material) itself may be extruded in the form of a monolith or in the form of pellets or beads. For example, the sorbent material may comprise a packed bed of sorbent bead material. The nature of the sorbent material will depend on the backpressure requirements of the system.

Most preferably the sorbent material comprises one or more zeolites or activated carbon. Preferably the sorbent material comprises a mixture of two or more zeolites. These may be provided in a zoned configuration with different zeolites in different regions of the storage material.

In one embodiment the sorbent material may be provided with a material suitable for the storage of volatile organic compounds (VOC). The storage and treatment of VOCs may allow for the odour of a livestock house to be ameliorated, as well as avoiding any associated health risks.

Volatile organic compounds can also be present in livestock house environments, either released from the animals or their environment (including feed and bedding). VOCs are defined by the WHO, as cited in ISO 16000-6, as any organic compound whose boiling point is in the range from (50° C. to 100° C.) to (240° C. to 260° C.), corresponding to having saturation vapour pressures at 25° C. greater than 102 kPa. VOCs include alcohols, aldehydes, amines, esters, ethers, hydrocarbons (up to about C10), ketones, nitrogen-containing compounds, phenols, indoles and other aromatic compounds, terpens and sulphur containing compounds. These are discussed in “characterisation of odour released during handling of swine slurry: Part I. Relationship between odorants and perceived odour concentrations” Blanes-Vidal et. al. Atmospheric Environment 43 (2009) 2997-3005, incorporated herein by reference.

In an embodiment the sorbent bed comprises two different sorbent materials for different species to be treated. For example, the system may be configured to treat ammonia and VOCs simultaneously. The material suitable for the storage of volatile organic compounds (VOC) may be the same material for the storage of ammonia, or a further material may be provided which has better storage performance for VOCs than ammonia. For example, a suitable material for the storage of a VOC would be a medium or large pore zeolite. At the same time a small pore zeolite would be present for the ammonia. Therefore, a mixture (in a mixed, zoned or layered configuration) of a small pore zeolite (for ammonia) and a medium/large pore zeolite (for VOCs) could be provided. Examples of preferred large pore zeolites include zeolite Y and Beta. In such embodiments the VOCs will be released at the same time and decomposed with the same oxidation catalyst. This may require higher catalyst temperatures than for ammonia alone.

Accordingly, in a preferred embodiment an ammonia storage material is provided together with a VOC storage material, wherein the ammonia storage material comprises a small pore zeolite and wherein the VOC storage material comprises a medium or large pore zeolite. Preferably the ammonia storage material and the VOC storage material are provided as a mixture, or in distinct zones, or in layers. For zoned configurations one material will be upstream of the other.

The number of sorbent beds required will depend on the size of the sorbent beds and the amount of the species to be treated. It may, for example, be desirable to have a large number of sorbent beds, but only have a subset in use. This will allow the capacity of the system to scale, for example to scale with animals as they age and produce more ammonia.

The system further comprises a treatment unit comprising either: one or more catalysts for decomposing the species or a condensing unit for recovering the species in liquid or aqueous form. By the term, “decomposing” it is meant that the species is treated so as to be converted into one or more other chemical species. The decomposed species is preferably converted so as to become one or more less harmful chemical species, such as converting ammonia into nitrogen and water. Alternatively, the inventors have found that the concentrated species may be condensed so as to recover the species (particularly wherein the species is ammonia) in liquid or aqueous form. The by-product may then be used as a useful feedstock, such as in a hydrogen fuel cell whereby the ammonia is fed to a reformer to generate hydrogen. The hydrogen can then be fed to a hydrogen fuel cell for electricity generation. The electricity generated may be fed back to operate the exhaust system (e.g. fans and heaters) thereby reducing the overall energy consumption.

Consequently, the present invention finds particular application in the treatment of an exhaust gas comprising ammonia since the inventors have found that a catalyst as described herein may be used to convert the ammonia into essentially nitrogen gas (N₂) and water (H₂O). On the contrary, known systems based on UV oxidation with ozone and photolysis result in the complete oxidation of any nitrogen present in the exhaust stream which leads to the generation of harmful nitrogen oxides (NOₓ) which is advantageously avoided using the present system.

Accordingly, it is preferred that the exhaust system does not comprise a photoreactor, a means for generating UV light or a means for generating ozone. It follows that the method preferably does not comprise photolysis or ozonolysis (i.e. suppling ozone for the oxidation of the species).

The nature of the catalyst will be determined by the species to be treated. Nonetheless, suitable catalysts for decomposing species are well known in the art. For ammonia, for example, materials known for use in ammonia slip catalysts are well known. The catalyst may comprise one or more PGMs, for example and may have a layered or zoned configuration.

The system comprises first and second exhaust gas outlets. The first exhaust gas outlet is for gas flowing simply past the sorbent bed, so that the gas passing out of the outlet has had the species to be treated adsorbed into the sorbent bed. The second exhaust gas outlet is for gas flowing away from the treatment catalyst, so that the species to be treated has been decomposed. In both cases the gas leaving the first and second gas outlets is depleted of the species to be treated. The level of depletion should be sufficient to meet the required emissions limits, but this will vary depending on the nature of the species.

The system comprises a valve system configured to establish independently for each sorbent bed fluid communication in a first or second configuration, wherein:
i) in the first configuration the flow of the dehumidified exhaust gas from the first gas inlet contacts a sorbent bed for storing the species and then passes to the first gas outlet; and
ii) in the second configuration the flow of heated gas from the second gas inlet contacts a sorbent bed for releasing the species, passes to one of the one or more catalysts and then passes to the second exhaust gas outlet.

The valve system is configured to ensure that at least one sorbent bed is in the first configuration and preferably at least one other sorbent bed is in the second configuration. As will be appreciated, the first configuration will result in the species being stored within the sorbent bed, whereas the second configuration will result in the species being released from the sorbent bed.

In general use the valve system will be configured to ensure that at least one sorbent bed is in the first configuration and at least one other sorbent bed is in the second configuration. It should of course be appreciated that this configuration is contemplated for the system when in operation, whereas during start-up or under certain conditions it may be required that all of the sorbent beds are in the first configuration storing the species so that there is a sufficient quantity to be treated. For example, if it takes 24 hours to charge a sorbent bed, but one hour to discharge the sorbent bed, then each bed will have non-overlapping discharging windows, but overlapping charging windows.

Preferably the valve system is configured to ensure that one sorbent bed is in the second configuration, and the remainder of the plurality of sorbent beds are in the first configuration. This means that where there are multiple sorbent beds, several are recharging and one is being discharged at each moment. In one embodiment there are two beds so that one is charging while one is discharging. In embodiments which store two species, such as ammonia and VOCs, these will also be released simultaneously.

Preferably the valve system is further configured to establish independently for each sorbent bed fluid communication a third configuration for cooling of the sorbent bed, wherein gases are prevented from leaving the sorbent bed. This is a desirable option because it prevents a circumstance whereby the sorbent bed is either connected to the first outlet but is still releasing levels of the stored species, or connected to the second outlet but is not being supplied at a sufficient temperature for catalyst treatment. In both cases there is a risk of undesirable species slip from the system. In an embodiment with three beds there would be one bed discharging, one bed cooling and one bed recharging, or one bed discharging and two beds recharging.

Preferably the dehumidified exhaust gas passing into the system through the first inlet comprises from1 to 5000 ppm of the species, preferably from 1 to 1000 ppm and most preferably from 1 to 500 ppm, such as 1 to 250 ppm and most preferably 1 to 100 ppm. The benefit of the invention is that the releasable storage achieved in the sorbent bed permits a concentration of the species. Preferably the concentration of the species passed to the one or more catalysts is at least 2 times greater than the initial exhaust gas, preferably at least 5 times and more preferably at least 10 times greater.

A preferred species to be treated in an exhaust gas is ammonia. When the species is ammonia, the catalyst is an ammonia oxidation catalyst and each sorbent bed comprises an ammonia storage material. As noted above, ammonia levels in a livestock house are desirably at most 20 ppm, but levels as high as 50 ppm may be observed. Therefore, the exhaust gas to be treated will contain from 2 to 250 ppm, preferably from 5 to 50 ppm and most preferably from 10 to 30 ppm. Gases leaving the exhaust gas system, either because of storage or decomposition, should have ammonia levels reduced to less than 20 ppm, preferably less than 10 ppm, more preferably less than 5 ppm and most preferably less than 1 ppm.

A preferred species to be treated in an exhaust gas is formaldehyde. When the species is formaldehyde the catalyst is a formaldehyde oxidation catalyst and each sorbent bed comprises a formaldehyde storage material. Formaldehyde levels are a problem in environments above 0.1 ppm so the system described herein coupled to an HVAC system needs to ensure that the formaldehyde concentration after treatment is less than 100 ppb, such as less than 50 ppb.

Another preferred species to be treated in an exhaust gas is methane. When the species is methane, the catalyst is a methane oxidation catalyst and each sorbent bed comprises a methane storage material. It is known that methane can be stored in certain metal-organic framework materials (MOF). The storage temperatures for efficient methane storage may require cooling of the sorbent beds. The catalyst for this application may comprise one or more PGMs.

Another preferred species to be treated in an exhaust gas are VOCs. When the species comprises VOCs, the catalyst is an oxidation catalyst and each sorbent bed comprises a VOC storage material.

Depending on the source of the exhaust gas it may be necessary to treat two or more of the above different preferred species simultaneously, such as providing the sorbent beds with two or more different sorbent materials and potentially employing two different catalysts. The sorbent materials and/or the catalysts could be provided in zoned or layers configurations.

The ppm concentrations of all of the above species may of course fluctuate because of the natural source of the species to be treated. The above ranges for concentrations are the average concentrations over the operating period of the exhaust gas system, excluding any start-up or warm-up period required for the system.

Preferably the system comprises one or more fans to push or pull gases through the system. The configuration of such a fan will depend on the desired air exchange rate required in the atmosphere to be treated.

Preferably the system further comprises one or more material filters to pre-filter the exhaust gas. Such filters are for recovering matter which could enter the system and clog or degrade the components of the system. For example, for poultry houses, there is a risk of feathers, fluff, straw and dust to be entrained into the air system which can be removed by such filters. Accordingly, it is preferred that such a filter is upstream of the dehumidifier system.

Preferably the system comprises a sorbent material for further contaminants upstream of the plurality of sorbent beds (i.e. upstream of the species storage material and, preferably, upstream of the water storage material of the dehumidifier system), wherein the further contaminant is selected from one or more of As, SO₂, SO₃, H₂S, Hg and Cl. By Hg and Cl it is meant any suitable mercury-containing and chlorine-containing species, respectively. Such contaminants are desirably removed in order to ensure that the one or more catalysts are not poisoned.

Preferably the system further comprises one or more sensors for the species in communication with each sorbent bed to determine a species loading status. Preferably the sensors are ammonia sensors in communication with each sorbent bed to determine an ammonia loading status. This can be used to control the valve system to ensure that beds are discharged before they become over full. Thus, the sensor detects the loading status and changes to a further flow path to store the pollutant in the storage medium when the Emission Limit of the pollutant in question over the storage medium is reached. By the term “ammonia sensor” it is meant any sensor that is capable of providing an indication of ammonia loading levels. A preferred sensor is an automotive NOₓ sensor since these are not expensive and since they cannot distinguish between NH₃ and NOₓ, where only NH₃ is present, the output of the NOₓ sensor gives an indication of NH₃ levels. Such sensors are well known in the art.

Preferably a further heater is provided immediately upstream of the one or each catalyst and after the sorbent bed being discharged with the heated gas flow. This is to ensure that the species released from the sorbent material is at a treatment temperature where the catalyst is working at a suitable efficiency. For ammonia treatment, for example, the catalysts typically have an optimal performance between 200 and 300° C. Accordingly, a further heater can be provided to ensure that the exhaust gas is raised to such a treatment temperature before contacting the catalyst. The specific heat achieved by this further heater will depend on the application and could be set by the person skilled in the art. The further heater can be electrical or based on combustion, as discussed above, such as a propane burner.

One or more of the filters, sorbent beds or catalysts described herein may comprise copper. Copper is known to have an antiviral effect. Thus, the presence of the copper in the system to contact the exhaust gas may have an antiviral effect which could reduce transmission of viruses via the exhaust gas. For example, a zeolite included in an ammonia storage material may comprise copper. Such copper may be loaded by ion exchange onto the zeolite. Preferably the copper-loading of the zeolite is in the range from 1 to 6 wt% of the zeolite.

According to a further aspect there is provided a complete system comprising both the source of the exhaust gas system to be treated and the exhaust system as described herein. Particular sources of the humid exhaust gas which may be especially suitable are a livestock house, HVAC installation or waste water treatment plant. A further example is a mine with a methane exhaust.

According to a further aspect there is provided a method of treating a humid exhaust gas comprising a species to be treated, the method comprising passing the humid exhaust gas through the exhaust system as described herein.

Preferred embodiments of the dehumidifier will now be further described. In one embodiment described under the section heading “dehumidifier valve system”, the dehumidifier system is based on equivalent features as described herein under the “valve system” and such features may extend equally to that of the “dehumidifier valve system” unless the context clearly indicates otherwise. A further embodiment of the dehumidifier is described under the section heading “dehumidifier wheel system”.

### Dehumidifier Valve System

In one preferred embodiment wherein the dehumidifier system comprises its own valve system, the dehumidifier system comprises:
a humid air inlet for providing a flow of humid exhaust gas;
a further gas inlet for providing a further flow of heated gas, preferably heated external air;
a plurality of water-sorbent beds, comprising a water storage material, for releasably storing water;
a further gas outlet in fluid communication with the first gas inlet;
an external gas outlet; and
a dehumidifier valve system configured to establish independently for each water-sorbent bed fluid communication in a first or second dehumidifier configuration, wherein:
   i) in the first dehumidifier configuration the flow of the humid exhaust gas from the humid air inlet contacts a water-sorbent bed for storing water and then passes to the further gas outlet; and
   ii) in the second dehumidifier configuration the further flow of heated gas from the further gas inlet contacts a water-sorbent bed for releasing the water to form a heated humidified gas which then passes to the external gas outlet;
wherein the dehumidifier valve system is configured to ensure that at least one water-sorbent bed is in the first dehumidifier configuration and, preferably at least one other water-sorbent bed is in the second dehumidifier configuration.

The dehumidifier system comprises a humid air inlet for providing a flow of humid exhaust gas. The humid air inlet provides the exhaust gas to be treated. The exhaust gas (i.e. humid exhaust gas) is taken from an atmosphere containing a species to be treated, such as a livestock house. The exhaust gas may be drawn into the inlet with a fan, and typically involves a conventional air intake within, for example, a livestock house air handling system.

The system comprises a further gas inlet for providing a further flow of heated gas. That is, the dehumidifier system comprises an equivalent to the second gas inlet providing a flow of heated gas. However, it will be appreciated that the further flow of heated gas is not untreated, species laden exhaust gas. Preferably, the further gas inlet draws in fresh air from outside of the system. However, the further gas inlet may make use of the treated exhaust gas after decomposition of the species (i.e. gas received from the second exhaust gas outlet). Similarly, the further gas inlet may preferably incorporate a heating device for providing the flow of heated gas to the water storage material, particularly where the gas is fresh air. Where the second gas inlet provides a flow of heated fresh air, the further and second gas inlets are preferably split from a single gas inlet. That is, a single heated fresh air stream is divided, such as with a y-shaped tubing configuration, to provide the further and second gas inlets as different forks in the gas flow path. Thus, the single gas inlet draws in the fresh air and divides it into two, passing a portion to the further inlet and a portion to the second inlet as required and dictated by the configuration of the valve system and dehumidifier valve system. This is advantageous since a single intake can be relied upon with a single fan to circulate the gases.

The volume of gas passing through the further gas inlet may be reduced compared to the volume of gas passing through the humid air inlet. That is, a majority of gas may be used to charge the sorbent beds, but the volume of gas being used to discharge a sorbent bed is preferably reduced to minimise the gas volume to be heated so as to desorb the water from the water storage material. Preferably the gas flow through the second gas inlet is at most defined by the total gas volume through the system divided by the number of sorbent beds in the system, and most preferably from 0.5 to 1, more preferably 0.6 to 0.8 times this value.

The humid air inlet will provide gas at the ambient temperature of the source gas. In the context of a livestock house, this will typically be from 10 to 40° C. as described herein.

The further gas inlet provides a flow of heated gas, such that the further gas inlet provides gas that is hotter than the gas from the humid air inlet. The system is therefore configured so that the flow of exhaust gas from the humid air inlet is at a temperature suitable for storage on the sorbent bed, whereas the flow of heated gas from the further gas inlet is at a higher temperature and is suitable for causing the release of at least a portion of the water on the sorbent bed. That is, the water is then desorbed from the water-sorbent bed with a smaller volume of heated gas than the volume of gas from which it has been recovered.

Preferably the further gas inlet incorporates a heating device for providing the flow of heated gas. Preferably the heating device is configured to provide a flow of gas at a temperature of from 100 to 600° C., preferably 100 to 350° C., preferably 150 to 200° C. The target temperature will depend on the heat needed to release the water from the downstream water-sorbent bed.

The heater can be electrical or based on combustion of a fuel. Preferably the heater is a gas burner, preferably a propane, natural gas or biogas burner. These are useful especially for locations such as livestock houses, since there tend to be available supplies of propane and the like on such sites. In one embodiment, propane may be supplied with gas from the first and/or second exhaust gas outlet as an oxygen source for combustion. Such an afterburner serves to further purify the gas being treated.

Preferably, the flow of heated gas is heated with heat obtained from the catalytic treatment of the species. By recycling the heat obtained from the exothermic decomposition of the species, the system can be maintained in an autothermal condition. In other words, the system can operate continuously without requiring any input of heat from an external heater but solely from the heat generated by the catalytic decomposition further improving the efficiency of system.

The system comprises a plurality of water-sorbent beds, the beds comprising a water storage material, for releasably storing water.

The water-sorbent material may preferably be disposed on a suitable substrate such as a honeycomb monolith, a corrugated substrate (such as corrugated glass-paper or quartz fibre sheet) or a plate. Alternatively, the sorbent material (storage material) itself may be extruded in the form of a monolith or in the form of pellets or beads. For example, the sorbent material may comprise a packed bed of sorbent bead material. The nature of the sorbent material will depend on the backpressure requirements of the system.

The number of sorbent beds required will depend on the size of the sorbent beds and the humidity of the exhaust gas to be treated. It may, for example, be desirable to have a large number of sorbent beds, but only have a subset in use. This will allow the capacity of the system to scale, for example to scale with animals as they grow and produce more water.

The dehumidifier system comprises a further gas outlet in fluid communication with the first gas inlet, and an external gas outlet. Where the first gas outlet is for the majority of the exhaust gas passing through the sorbent bed and having had the species removed, and then released to the atmosphere, the equivalent further gas outlet of the dehumidifier system instead directs the exhaust gas to the first gas inlet so that the species contained therein can be treated. Accordingly, the further gas outlet is for gas flowing past (passing through) the water storage material so that the gas passing out of the outlet has had the water of the humid exhaust gas adsorbed onto the water storage material. Such dehumidified exhaust gas retains the species to be treated and the further gas outlet is therefore provided in fluid communication with the first gas inlet.

Whereas the second gas outlet is supplied by gas from a treatment unit, water is non-toxic and the heated humidified gas does not need to be treated before being released to the atmosphere. A flow of heated gas (which does not comprises any species to be treated; preferably heated external air) is used to contact and pass through the water storage material as required so as to release the water stored therein. This forms a heated humidified gas which then passes to the external gas outlet and to the atmosphere. This regenerates the water storage material so that the humid exhaust gas may continue to be dehumidified using an equivalent mechanism as that described herein for the treatment of the species. One notable exception is that the released water is not a pollutant species which needs to be treated (unlike ammonia, formaldehyde, methane and VOCs). As described herein, it is preferred that heat is recovered from the heated humidified gas.

The dehumidifier system comprises a dehumidifier valve system configured to establish independently for each water-sorbent bed fluid communication in a first or second dehumidifier configuration, wherein:
i) in the first dehumidifier configuration the flow of the humid exhaust gas from the humid air inlet contacts a water-sorbent bed for storing water and then passes to the further gas outlet; and
ii) in the second dehumidifier configuration the further flow of heated gas from the further gas inlet contacts a water-sorbent bed for releasing the water to form a heated humidified gas which then passes to the external gas outlet.

The dehumidifier valve system is configured to ensure that at least one water-sorbent bed is in the first dehumidifier configuration and preferably at least one other water-sorbent bed is in the second dehumidifier configuration. As will be appreciated, the first dehumidifier configuration will result in the water being stored within the water-sorbent bed, whereas the second dehumidifier configuration will result in the water being released from the water-sorbent bed.

In general use the dehumidifier valve system will be configured to ensure that at least one water-sorbent bed is in the first dehumidifier configuration and at least one other water-sorbent bed is in the second dehumidifier configuration. It should of course be appreciated that this configuration is contemplated for the system when in operation, whereas during start-up or under certain conditions it may be that all of the water-sorbent beds are in the first dehumidifier configuration in the absence of a need to regenerate the water storage material of a bed and whilst the rest of the exhaust system reaches a steady state of operation.

Preferably the dehumidifier valve system is further configured to establish independently for each water-sorbent bed fluid communication a third dehumidifier configuration for cooling of the water-sorbent bed, wherein gases are prevented from leaving the sorbent bed. This is a desirable option because it prevents a circumstance whereby the sorbent bed is connected to the further gas outlet but is still releasing water. In an embodiment with three beds there would be one bed discharging, one bed cooling and one bed recharging, or one bed discharging and two beds recharging.

Preferably the humid exhaust gas passing into the dehumidifier system through the humid air inlet comprises from 1 to 5000 ppm of the species (i.e. equivalent to that described herein with regard to the dehumidified exhaust gas).

Preferably the dehumidifier system comprises one or more fans to push or pull gases through the system. The configuration of such a fan will depend on the desired air exchange rate required in the atmosphere to be treated. Such fans may also serve to push or pull gas through the remainder of the “valve system” described herein.

Preferably the dehumidifier system further comprises one or more humidity sensors in communication with each sorbent bed to determine a water loading status.

### Dehumidifier Wheel System

In another preferred embodiment wherein the dehumidifier system is configured so that the selected portion of the water storage material changes over time (referred to herein generally as the “dehumidifier wheel system”), the dehumidifier system comprises:
a humid air inlet for providing a flow of humid exhaust gas;
a water storage material arranged to receive the humid exhaust gas from the humid air inlet;
a further gas outlet for receiving dehumidified exhaust gas passing through the water storage material, which is in fluid communication with the first gas inlet;
an external gas outlet arranged downstream of a selected portion of the water storage material; and
a further gas inlet for providing a further flow of heated gas, preferably heated external air, arranged to pass through the selected portion of the water storage material to release water stored therein and to form a heated humidified gas which passes through the external gas outlet.

The dehumidifier system comprises a humid air inlet. This will be the air-intake for providing a flow of humid exhaust gas (source gas). The humid air inlet provides the humid exhaust gas to be treated. The exhaust gas may be drawn into the inlet with a fan, and typically involves a conventional air intake within, for example, a livestock house air handling system.

The humid air inlet will provide gas at the ambient temperature of the source gas as described above. The temperature of the ambient air in the house may be controlled with heating and/or cooling. In general, for certain animals it may not be necessary to provide heating in winter.

The system comprises a water storage material arranged to receive the humid exhaust gas from the humid air inlet.

As described for the “dehumidifier valve system” the water storage material may preferably be disposed on a suitable substrate such as a honeycomb monolith, a corrugated substrate (such as corrugated glass-paper or quartz fibre sheet), or a plate. Alternatively, the sorbent material (storage material) itself may be extruded in the form of a monolith or in the form of pellets or beads. For example, the sorbent material may comprise a packed bed of sorbent bead material. The nature of the sorbent material will depend on the backpressure requirements of the system.

The “dehumidifier wheel system” comprises a further gas outlet equivalent to that described above for the “dehumidifier valve system”. The further gas outlet receives dehumidified exhaust gas from gas flowing past (passing through) the water storage material so that the gas passing out of the outlet has had the water of the humid exhaust gas adsorbed onto the water storage material. Equally, the further gas outlet is in fluid communication with the first gas inlet of the exhaust system.

Furthermore, the “dehumidifier wheel system” further comprises an equivalent further gas inlet for providing a further flow of heated gas. A flow of heated gas (which does not comprises any species to be treated; preferably heated external air) is used to contact and pass through a selected portion of the water storage material, as required so as to release the water stored therein. This forms a heated humidified gas which then passes to the external gas outlet and to the atmosphere. This regenerates the selected portion of the water storage material so that the humid exhaust gas may continue to be dehumidified using a mechanism whereby the selected portion of the water storage material changes over time.

The system preferably comprises a heating device for heating gas before it passes through the selected portion of the water storage material to release water stored therein for release to the atmosphere. The heater is configured to heat only gas going through a selected portion, so only the water on that portion is released. That is, the humid exhaust gas does not pass through the selected portion of the ammonia storage material is not heated by the heater and therefore remains at ambient temperature for water absorption.

The selected portion of the water storage material will preferably be at most 50% of the water storage material. However, preferably the selected portion will be from 1 to 15%, preferably 5 to 10% of the water storage material. When the water storage material is a rotating sorbent bed as discussed below, the selected portion will be a sector extending from the central axis. The size of the selected portion determines the proportion of the water storage material which is discharging water and the portion which is charging; preferably there is at least 5 times more of the water storage material charging than discharging.

Preferably the heating device is configured to heat the gas before it passes through the selected portion of the water storage material to a temperature of from 50 to 300° C., preferably 100 to 250° C. and most preferably 150 to 200° C. The target temperature will depend on the heat needed to release stored water from the downstream water storage material.

The heater is intended to heat only the selected portion so that the remainder of the water storage material can continue to accrue water from the humid exhaust gas flow. The air which is being heated may be fresh air taken from a fresh air inlet as described above.

In one configuration the heating device may be located between the water storage material and the one or more catalysts and wherein the system further comprises a duct for recycling at least a portion of the gas treated on the catalyst to upstream of the selected portion of the water storage material. That is, the system can recycle some of the gas passing out of the treatment unit to a position upstream of the selected portion of the water storage material to provide the heated flow of gas.

Alternatively, the heating device may be a heat exchanger arranged to recover heat from gas downstream of the treatment unit, preferably the one or more catalysts. In this embodiment the gas passing out of the treatment unit is not physically recycled, but it has its heat recovered by the heat exchanger and is used to heat fresh air passing to the selected portion of the water storage material. The heat exchanger may serve as a condensing unit so as to recover heat by condensing the species liberated from the sorbent bed. By using such a heat exchanger, the inventors have found that a further heater upstream of the selected portion of the water storage material is not required such that, preferably, there is no further heater upstream of the selected portion of the water storage material.

The system is configured so that the selected portion of the water storage material changes over time. This means that there is one portion of the water storage material which is being discharged of water, while a remainder (one or more further portions) of the water storage material is being charged with water. Since the selected portion changes over time, each portion will have a first time period when it is charging with water and a second time period when it is discharging the water.

Various configurations of the system can be envisioned whereby the selected portion of the water storage material changes over time. In each instance the selected portion needs to move relative to the supply of heated gas and relative to the external gas outlet arranged downstream of the selected portion of the water storage material. Given the complexity of the ducting and the simplicity of the water storage material (such as a sorbent bed), it will generally be most appropriate to move the water storage material.

A particularly preferred arrangement to allow for the selected portion of the ammonia storage material to change over time is for the water storage material to be configured as a rotating sorbent bed. That is, preferably the water storage material is provided within a sorbent bed which is arranged to rotate so that, in use, different portions of the water storage material are each contacted with a heated gas in turn.

For a rotating sorbent bed, the bed can preferably be configured to rotate continuously at a constant rate. Alternatively, the bed can be configured to rotate stepwise at pre-set, preferably uniform, intervals (a “revolver cylinder” type configuration). Continuous rotation is preferred since this ensures a consistent rate of dehumidifying the exhaust gas and since this reduces wear on the system components. Typical rotation rates, in either rotation configuration, will be in the region of 0.5 to 4 rotations per hour, preferably about 1 rotation per hour. A suitable rotation rate will depend on the humidity of the the exhaust gas and the size of the bed and can be tuned to the specific application. A primary consideration is that the wheel needs to rotate at a sufficiently slow rate such that it cools for effective storage of water before it is heated again for water release. Indeed, the rotation rate can be changed on the fly responsive to water levels in the exhaust gas.

Preferably the system further comprises one or more humidity sensors downstream of the remainder of the water storage material, i.e. not downstream of the selected portion, to determine a water loading status. This can be used to control the rotation rate to ensure that water storage material is discharged before it becomes over full.

For a rotating sorbent bed the preferred bed size is such that it has a diameter of from 10 cm to 600 cm, preferably 100 to 450 cm, more preferably 200 to 400 cm, for example 300 cm. Preferably, the sorbent bed has a depth of 5 to 50 cm, preferably 10 to 20 cm. As will be appreciated, the rotating beds can therefore have a significant water storage capacity. The size of the wheel can be scaled down or up depending on a number of factors, for example, the quantity of water (larger animals will generate higher quantities) and the back-pressure generated (which itself will be dependent on a variety of factors, e.g. sorbent depth, fan size). The main factor in the wheel size is the pressure-drop requirements, with larger wheel sizes permitting lower pressure drop requirements, meaning less powerful driving fans are required with an associated lower energy cost. A wheel size of 2-4 m can permit a pressure drop as low as 2 mbar or even 1 mbar.

Gas flow rates through the system would be expected to peak in the region of 100 to 300 km³/h, such as about 200 km³/h, with faster rates required in summer than in winter.

As can be appreciated from a rotating sorbent bed, the bed will have a portion receiving the ambient air from the, for example, a poultry house, at an ambient temperature. This portion of the bed will be efficiently storing water. The selected portion receiving heated gas will be at an elevated temperature as mentioned above, such as 150° C. However, a portion which has just been rotated away from the source of heated gas will take time to cool to ambient temperature. During this period there is an increased risk of water slip leading to the rest of exhaust system and treatment unit.

Preferably, the system comprises means for cooling a previously-heated portion of the water storage material with a supply of ambient air. The ambient air may be ambient exhaust gas, for example from the livestock house. In some embodiments, it is preferred that the ambient air is ambient fresh air. In a particularly preferred embodiment, the supply of ambient air can be coupled with a heat exchanger to allow use of the heat being recovered elsewhere in the system. That is, heat from the previously-heated portion of the water storage material may be recovered through the use of an ambient air flow which is then further heated, preferably using a heat exchanger arranged to recover heat from gas downstream of the treatment unit as described herein, so as to provide the heated gas (i.e. a separate gas stream) which passes through the selected portion of the water storage material. Preferably the previously-heated portion of the water storage material is cooled with a flow counter to the normal direction of gases through the water storage material. This means that the gas flow avoids any ammonia slip, since any water is carried back upstream of the cooling water storage material and is then retained on ambient temperature water storage material. The rotating sorbent bed can comprise a plurality of inserts comprising the water storage material. In such an embodiment the plurality of inserts would be releasably held in a supporting frame structure so as to provide storage material for the exhaust gas to pass through while minimising any gas bypassing the storage material.

Preferably the system further comprises one or more material filters between the humid air inlet and the water storage material. That is, the system comprises filters to perform an initial screen of matter which could affect the performance of the downstream exhaust system. When treating air from a poultry house, such a material filter can be used to remove entrained feathers, fluff, straw, dust and the like.

As discussed above, preferably the system comprises one or more fans to push or pull gases through the system. The configuration of such a fan will depend on the desired air exchange rate required in the atmosphere to be treated. Advantageously the entire system can be driven by a single fan.

### Dehumidifier System

Preferably, the water storage material comprises one or more sorbents selected from silica gel, activated alumina, a zeolite and a metal-organic framework (MOF). As will be appreciated, the water storage material will have greater affinity to water over the species to be treated so as to accumulate and remove the water from the humid gas. The specific water storage material may be readily selected by a skilled person so as to preferentially store water over the species to be treated. For example, a small pore zeolite may be preferred for the dehumidifier system where VOCs are treated since a small pore can exclude the VOCs. In a particularly preferred embodiment, the water storage material is an alkali metal loaded zeolite. Alkali metal loaded zeolites (e.g. sodium loaded zeolite) are especially suitable for use in treatment of a humid gas comprising ammonia. Water will typically displace ammonia and alkali metal loaded zeolites have particularly high affinity for water over ammonia permitting storage of water in preference to ammonia. Zeolites generally desorb water at much lower temperatures than ammonia which is also beneficial for reducing ammonia slip during regeneration of the water storage material. Consequently, the water storage material may be selected based on known affinities of the material for water and ammonia (and other pollutant species).

The heated humidified gas may be released to the atmosphere. In a particularly preferred embodiment, the dehumidifier system further comprises means for recovering heat from the heated humidified gas. Preferably, the means is a heat exchanger and the heat exchanger is used to provide heat to another part of the exhaust system, preferably to provide a flow of heated gas as described herein. Accordingly, in use, the heat exchanger may condense the water in the heated humidified gas so as to recover heat. Cooled liquid water and gases are then released to the atmosphere.

The invention will now be described in relation to the following non-limiting figures, in which:

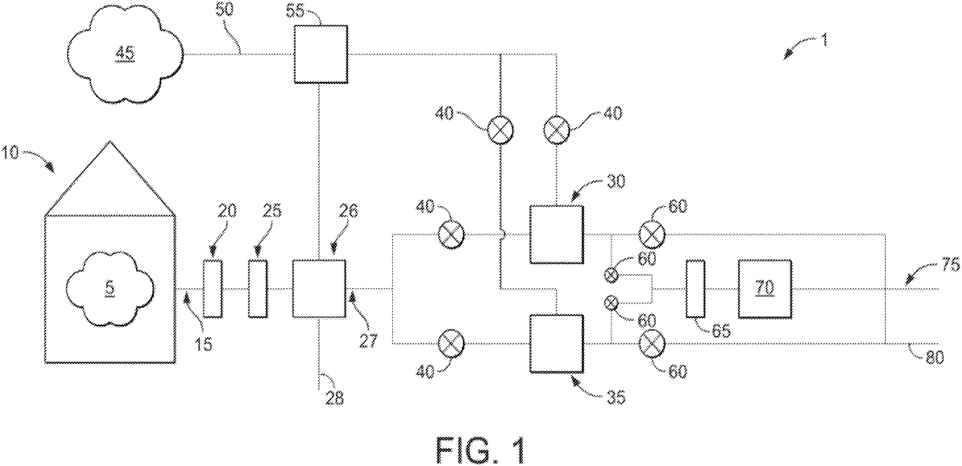

FIG. 1 shows a schematic of an exhaust system according to claim 1.

FIG. 1 shows an exhaust gas system 1 as described herein. The exhaust gas system 1 is configured to process a humid exhaust gas 5 from a livestock house 10. The humid exhaust gas 5 passes through an exhaust gas inlet 15 into the exhaust gas treatment system 1.

The humid exhaust gas 15 passes through a coarse material filter 20 to remove matter such as poultry feathers and then through a H₂S sorbent filter 25. The humid exhaust gas 5 then passes to a dehumidifier system 26 so as to remove the moisture from the humid exhaust gas 5. The dehumidifier system 26 comprises an outlet 27 through which a flow of dehumidified exhaust gas is communicated with the remainder of the exhaust system 1. The dehumidified exhaust gas passes through a first gas inlet to either a first sorbent bed 30 or a second sorbent bed 35, depending on a valve system comprising valves 40.

A source of fresh air 45 is fed through a fresh air inlet 50 to a propane heater 55. Depending on the valve system, the heated fresh air passes to either the first sorbent bed 30 or the second sorbent bed 35. Similarly, in one embodiment the dehumidifier system comprises an independent dehumidifier valve system configured to direct gases (e.g. humid exhaust gas 5 and heated fresh air) through a plurality of water sorbent beds (not shown).

The valves 40 of the valve system is configured so that one of the first sorbent bed 30 and the second sorbent bed 35 receives the exhaust gas 5 and the other receives the fresh air 45.

A further valve system comprising further valves 60 is provided to direct the gas leaving the first sorbent bed 30, via an electrical heater 65 to an ammonia oxidation catalyst 70 and to a catalyst-treated exhaust gas outlet 75, or directly to a further exhaust gas outlet 80. At the same time the further valves 60 are configured to direct the gas leaving the second sorbent bed 35 to the other outlet (80, 75). Similarly, a flow of heated gas supplied to the dehumidifier system may be directed via valves to contact a water saturated sorbent bed to liverate the water stored therein and which then passes to external gas outlet 38.

In one embodiment gas leaving the catalyst-treated exhaust gas outlet 75 or the further exhaust gas outlet 80 may be recycled to the heater 55 as a combustion gas.

In one embodiment gas leaving the sorbent bed 30, 35 may be recycled into the house 10. In one embodiment gas leaving the catalyst-treated exhaust gas outlet 75, together with a larger exhaust mass flow towards 80 may be recycled into the house 10 if the mixing temperature of both streams permit.

Although preferred embodiments of the invention have been described herein in detail, it will be understood by those skilled in the art that variations may be made thereto without departing from the scope of the invention or of the appended claims.

1. An exhaust system for the treatment of a humid exhaust gas comprising a species to be treated, the system comprising:
a dehumidifier system comprising a humid air inlet for providing a flow of humid exhaust gas;
a first gas inlet for providing a flow of dehumidified exhaust gas;
a second gas inlet for providing a flow of heated gas;
a plurality of sorbent beds for releasably storing the species;
a treatment unit comprising either:
one or more catalysts for decomposing the species; or
a condensing unit for recovering the species in liquid or aqueous form;
first and second exhaust gas outlets; and
a valve system configured to establish independently for each sorbent bed fluid communication in a first or second configuration, wherein:
i) in the first configuration the flow of the dehumidified exhaust gas from the first gas inlet contacts a sorbent bed for storing the species and then passes to the first gas outlet; and
ii) in the second configuration the flow of heated gas from the second gas inlet contacts a sorbent bed for releasing the species, passes to the treatment unit and then passes to the second exhaust gas outlet;
wherein the valve system is configured to ensure that at least one sorbent bed is in the first configuration and, at least one other sorbent bed is in the second configuration;
wherein the flow of dehumidified exhaust gas provided by the first gas inlet is received from the dehumidifier system.

2. The exhaust system according to claim 1, wherein the dehumidifier system comprises:
a humid air inlet for providing a flow of humid exhaust gas;
a further gas inlet for providing a further flow of heated gas;
a plurality of water-sorbent beds, comprising a water storage material, for releasably storing water;
a further gas outlet in fluid communication with the first gas inlet;
an external gas outlet; and
a dehumidifier valve system configured to establish independently for each water-sorbent bed fluid communication in a first or second dehumidifier configuration, wherein:
i) in the first dehumidifier configuration the flow of the humid exhaust gas from the humid air inlet contacts a water-sorbent bed for storing water and then passes to the further gas outlet; and
ii) in the second dehumidifier configuration the further flow of heated gas from the further gas inlet contacts a water-sorbent bed for releasing the water to form a heated humidified gas which then passes to the external gas outlet;
wherein the dehumidifier valve system is configured to ensure that at least one water-sorbent bed is in the first dehumidifier configuration and, preferably at least one other water-sorbent bed is in the second dehumidifier configuration.

3. The exhaust system according to claim 1, wherein the dehumidifier system comprises:
a humid air inlet for providing a flow of humid exhaust gas;
a water storage material arranged to receive the humid exhaust gas from the humid air inlet;
a further gas outlet for receiving dehumidified exhaust gas passing through the water storage material, which is in fluid communication with the first gas inlet;
an external gas outlet arranged downstream of a selected portion of the water storage material; and
a further gas inlet for providing a further flow of heated gas arranged to pass through the selected portion of the water storage material to release water stored therein and to form a heated humidified gas which passes through the external gas outlet;
wherein the dehumidifier system is configured so that the selected portion of the water storage material changes over time.

4. The exhaust system according to claim 1, wherein:
i) the species is ammonia, the catalyst is an ammonia oxidation catalyst and wherein each sorbent bed comprises an ammonia storage material; or
ii) the species is formaldehyde, the catalyst is a formaldehyde oxidation catalyst and wherein each sorbent bed comprises a formaldehyde storage material; or
iii) the species is methane, the catalyst is a methane oxidation catalyst and wherein each sorbent bed comprises a methane storage material; or
(iv) the species comprises VOCs, the catalyst is an oxidation catalyst and wherein each sorbent bed comprises a VOC storage material.

5. The exhaust system according to claim 1, wherein the humid exhaust gas comprises from 1 to 5000 ppm of the species.

6. The exhaust system according to claim 1, wherein the humid exhaust gas is at a temperature at least 25° C. below an effective catalyst treatment temperature.

7. The exhaust system according to claim 1, wherein the second gas inlet incorporates a heating device for providing the flow of heated gas.

8. The exhaust system according to claim 7, wherein the heating device is configured to provide a flow of gas at a temperature of from 100 to 600° C. .

9. The exhaust system according to claim 1, wherein dehumidified exhaust gas is supplied to both the first and second gas inlets, or wherein the second gas inlet is an air inlet.

10. The exhaust system according to claim 1, wherein the system further comprises one or more material filters to pre-filter the exhaust gas.

11. The exhaust system according to claim 1, wherein the system comprises a contaminant sorbent material upstream of the plurality of sorbent beds, wherein the contaminant is selected from one or more of As, SO₂, SO₃, H₂S, Hg and Cl.

12. The exhaust system according to claim 1, wherein the valve system is configured to ensure that one sorbent bed is in the second configuration, and the remainder of the plurality of sorbent beds are in the first configuration.

13. The exhaust system according to claim 1, the system further comprising one or more sensors for the species in communication with each sorbent bed to determine a species loading status .

14. (canceled)

15. The exhaust system according to claim 1, wherein the treatment unit comprises one or more catalysts for decomposing the species, and wherein a further heater is provided immediately upstream of the one or each catalyst.

16. The exhaust system according to claim 1, wherein the valve system is further configured to establish independently for each sorbent bed fluid communication a third configuration for cooling of the sorbent bed, wherein gases are prevented from leaving the sorbent bed.

17. The exhaust system according to claim 1, wherein the treatment unit comprises one or more catalysts for decomposing the species, and wherein the flow of heated gas is heated with heat obtained from the catalytic treatment of the species, whereby the system can be maintained in an autothermal condition.

18. (canceled)

19. The exhaust system according to claim 2, wherein the dehumidifier system further comprises means for recovering heat from the heated humidified gas.

20. The exhaust system according to claim 19, wherein the means is a heat exchanger and the heat exchanger is used to provide heat to another part of the exhaust system, preferably to provide the further flow of heated gas.

21. A livestock house, HVAC installation, waste water treatment plant, or a mine, comprising the exhaust system according to claim 1.

22. A method of treating a humid exhaust gas comprising a species to be treated, the method comprising passing the humid exhaust gas through the exhaust system according to claim 1.
